(19) United States
(12) Patent Application Publication
(10) Pub. No.: US 2026/0056563 A1
(43) Pub. Date: Feb. 26, 2026

(54) TEMPERATURE ADJUSTING SYSTEM, CONTROLLER, DEVICE HANDLING APPARATUS, TESTER, AND DEVICE TESTING APPARATUS

(71) Applicant: ADVANTEST Corporation, Tokyo (JP)

(72) Inventor: Yuya Yamada, Tokyo (JP)

(73) Assignee: ADVANTEST Corporation, Tokyo (JP)

(21) Appl. No.: 19/217,482

(22) Filed: May 23, 2025

(30) Foreign Application Priority Data
Jun. 3, 2024 (JP) 2024-090233

(51) Int. Cl. G05D 23/19; G01N 25/00

(52) U.S. Cl. CPC G05D 23/1917; G01N 25/00

(57) ABSTRACT

A temperature adjusting system includes a temperature adjuster that adjusts a temperature of a device under test (DUT) including first temperature detecting circuits, first acquirers each of which acquires a first signal, output from a corresponding one of the first temperature detecting circuits, indicating an internal temperature of the DUT, and outputs a second signal, and a controller that controls the temperature adjuster based on the output second signals.

### CROSS-REFERENCE TO RELATED APPLICATIONS

The present application claims priority to Japanese Patent Application No. 2024-090233, filed on Jun. 3, 2024. The contents of this application are incorporated herein by reference in their entirety.

### BACKGROUND

### Technical Field

The present invention relates to a temperature adjusting system and a controller used for adjusting the temperature of a device under test (hereinafter simply referred to as a “DUT” (Device Under Test)) such as a semiconductor integrated circuit element, and a device handling apparatus, a tester and a device testing apparatus used for testing the DUT.

### Discussion of the Background

The electronic device testing apparatus includes a controller that calculates the temperature of a DUT using an analog signal outputted from a thermal diode provided in the DUT and controls a temperature adjusting device based on the calculation result (refer to, for example, Patent Document 1).

### Patent Document

Patent Document 1: US 2019/0101587 A1

Generally, only one thermal diode is provided in the DUT. On the other hand, during the testing of the DUT, the entire circuit of the DUT is not driven at the same time, and the circuit is partially driven, therefore the temperature distribution of the DUT may be non-uniform. Therefore, when the thermal diode is located far away from the driving portion of the circuit, an error may occur between the actual temperature of the driving portion and the measurement result of the thermal diode.

### SUMMARY

One or more embodiments provide a temperature adjusting system, a controller, a device handling apparatus, a tester, and a device testing apparatus capable of improving the accuracy of temperature adjustment.

An aspect 1 of one or more embodiments is a temperature adjusting system comprising: a temperature adjuster that adjusts a temperature of a device under test (DUT) including first temperature detecting circuits; first acquirers each of which acquires a first signal and outputs a second signal, the first signal being outputted from the first temperature detecting circuit and indicating an internal temperature of the DUT; and a controller that controls the temperature adjuster using the second signals outputted from the first acquirers.

An aspect 2 of one or more embodiments may be the temperature adjusting system of the aspect 1, wherein the controller may comprise a selecting unit that one or more second signals from the second signals outputted from the first acquirers, and the controller may control the temperature adjuster using the one or more second signals.

An aspect 3 of one or more embodiments may be the temperature adjusting system of the aspect 2, wherein the controller may comprise a calculating unit that calculates a third signal using the one or more second signals selected by the selecting unit, and the controller may control the temperature adjuster using the third signal.

An aspect 4 of one or more embodiments may be the temperature adjusting system of the aspect 2 or 3, wherein the selecting unit may select the one or more second signals based on a heat generating portion of the DUT.

An aspect 5 of one or more embodiments may be the temperature adjusting system of the aspect 3 or 4, wherein the calculating unit may calculate the third signal based on a heat generating portion of the DUT.

An aspect 6 of one or more embodiments may be the temperature adjusting system of the aspect 1, wherein the controller may comprise a calculating unit that calculates a third signal using the second signals outputted from the first acquirers, the controller may control the temperature adjuster using the third signal.

An aspect 7 of one or more embodiments may be the temperature adjusting system of the aspect 6, wherein the calculating unit may calculate the third signal based on a heat generating portion of the DUT.

An aspect 8 of one or more embodiments may be the temperature adjusting system of any one of the aspects 1 to 7, wherein the controller may comprise an identifying unit that identifies a heat generating portion of the DUT based on a test program that is currently being executed to test the DUT.

An aspect 9 of one or more embodiments may be the temperature adjusting system of any one of the aspects 1 to 8, wherein the controller may comprise an identifying unit that identifies a heat generating portion of the DUT based on a test that is currently being performed to test the DUT.

An aspect 10 of one or more embodiments may be the temperature adjusting system of any one of the aspects 1 to 9, wherein the second signal may be irregularly outputted from the first acquirer, and the controller may comprise converting units each of which converts the second signal from an irregular signal to a regular signal.

An aspect 11 of one or more embodiments may be the temperature adjusting system of any one of the aspects 1 to 10, wherein each of the first acquirers may comprise an acquiring unit that acquires the first signal from the first temperature detecting circuit using a test program that executes a test of the DUT.

An aspect 12 of one or more embodiments may be the temperature adjusting system of any one of the aspects 1 to 11, wherein each of the first acquirers may generate the second signals using the first signal.

An aspect 13 of one or more embodiments may be the temperature adjusting system of any one of the aspects 1 to 12, wherein the first signal outputted from the first temperature detecting circuit may be a first digital signal.

An aspect 14 of one or more embodiments may be the temperature adjusting system of any one of the aspects 1 to 13, wherein each of the first temperature detecting circuits may comprise: a measuring unit that measures the internal temperature of the DUT; and a calibrating unit that calibrates a measurement result of the measuring unit, and the first temperature detecting circuit may output the measurement result calibrated by the calibrating unit as the first signal to the first acquirer.

An aspect 15 of one or more embodiments may be the temperature adjusting system of any one of the aspects 1 to 14, wherein the first temperature detecting circuits are disposed apart from each other in a plan view of the DUT.

An aspect 16 of one or more embodiments may be the temperature adjusting system of any one of the aspects 1 to 15, wherein the temperature adjusting system may further comprise: a second acquirer that acquires a fourth signal and outputs a fifth signal, the fourth signal being outputted from a second temperature detecting circuit included in the DUT and indicating an internal temperature of the DUT, wherein a controller may control the temperature adjuster using the second signals and the fifth signal.

An aspect 17 of one or more embodiments may be the temperature adjusting system of the aspect 16, wherein the fourth signal outputted from the second temperature detecting circuit may be an analog signal.

An aspect 18 of one or more embodiments may be the temperature adjusting system of the aspect 16 or 17, wherein the second temperature detecting circuit may include a thermal diode.

An aspect 19 of one or more embodiments may be the temperature adjusting system of any one of the aspects 16 to 18, wherein the second acquirer may comprise an A/D converter that converts the analog signal into a second digital signal, and the second acquirer may output the second digital signal as the fifth signal.

An aspect 20 of one or more embodiments may be the temperature adjusting system of any one of the aspects 1 to 19, wherein the temperature adjusting system may further comprise: a temperature sensor disposed in a pusher that presses the DUT or a carrier containing the DUT against a socket, wherein the controller may control the temperature adjuster using the second signals and a detection result of the temperature sensor.

An aspect 21 of one or more embodiments is a controller that controls a temperature adjuster that adjusts a temperature of a device under test (DUT) including first temperature detecting circuits, wherein the controller controls the temperature adjuster using second signals outputted from first acquirers, the second signal is a signal outputted from the first acquirer that acquires a first signal outputted from the first temperature detecting circuit, and the first signal indicates an internal temperature of the DUT.

An aspect 22 of one or more embodiments may be the controller of the aspect 21, wherein the controller may comprise a selecting unit that selects one or more second signals from the second signals outputted from the first acquirers, and the controller may control the temperature adjuster using the one or more second signals.

An aspect 23 of one or more embodiments may be the controller of the aspect 22, wherein the controller may comprise a calculating unit that calculates a third signal using the one or more second signals selected by the selecting unit, and the controller may control the temperature adjuster using the third signal.

An aspect 24 of one or more embodiments may be the controller of the aspect 22 or 23, wherein the selecting unit may select the one or more second signals based on a heat generating portion of the DUT.

An aspect 25 of one or more embodiments may be the controller of the aspect 23 or 24, wherein the calculating unit may calculate the third signal based on a heat generating portion of the DUT.

An aspect 26 of one or more embodiments may be the controller of the aspect 21, wherein the controller may comprise a calculating unit that calculates a third signal using the second signals outputted from the first acquirers, the controller may control the temperature adjuster using the third signal.

An aspect 27 of one or more embodiments may be the controller of the aspect 26, wherein the calculating unit may calculate the third signal based on a heat generating portion of the DUT.

An aspect 28 of one or more embodiments may be the controller of any one of the aspects 21 to 27, wherein the controller may comprise an identifying unit that identifies a heat generating portion of the DUT based on a test program that is currently being executed to test the DUT.

An aspect 29 of one or more embodiments may be the controller of any one of the aspects 21 to 28, wherein the controller may comprise an identifying unit that identifies a heat generating portion of the DUT based on a test that is currently being executed to test the DUT.

An aspect 30 of one or more embodiments may be the controller of any one of the aspects 21 to 29, wherein the second signal may be irregularly outputted from the first acquirer, and the controller may comprise converting units each of which converts the second signal from an irregular signal to a regular signal.

An aspect 31 of one or more embodiments is a device handling apparatus that handles a device under test (DUT) including first temperature detecting circuits or a carrier containing the DUT and presses the DUT or the carrier against a socket, the device handling apparatus comprising: a temperature adjuster that adjusts a temperature of the DUT; and the controller of any one of the aspects 21 to 30.

An aspect 32 of one or more embodiments may be the device handling apparatus of the aspect 31, wherein the device handling apparatus may further comprise: a second acquirer that acquires a fourth signal and outputs a fifth signal, the fourth signal being outputted from a second temperature detecting circuit included in the DUT and indicating an internal temperature of the DUT, the fifth signal corresponding to the internal temperature of the DUT, wherein a controller controls the temperature adjuster using the second signals and the fifth signal.

An aspect 33 of one or more embodiments may be the device handling apparatus of the aspect 32, wherein the fourth signal outputted from the second temperature detecting circuit may be an analog signal.

An aspect 34 of one or more embodiments may be the device handling apparatus of the aspect 32 or 33, wherein the second temperature detecting circuit may include a thermal diode.

An aspect 35 of one or more embodiments may be the device handling apparatus of any one of the aspects 32 to 34, wherein the second acquirer may comprise an A/D converter that converts the analog signal into a second digital signal, and the second acquirer may output the second digital signal as the fifth signal.

An aspect 36 of one or more embodiments may be the device handling apparatus of any one of the aspects 31 to 35, wherein the device handling apparatus may further comprise: a pusher that presses the DUT or the carrier against a socket; and a temperature sensor disposed in the pusher, wherein the controller may control the temperature adjuster using the second signals and a detection result of the temperature sensor.

An aspect 37 of one or more embodiments is a tester that tests a device under test (DUT) electrically connected to a socket or the DUT contained in a carrier electrically connected to the socket, the DUT including first temperature detecting circuits, the tester comprising: first acquirers each of which acquires a first signal and outputs a second digital signal, the first signal being outputted from the first temperature detecting circuit and indicating an internal temperature of the DUT.

An aspect 38 of one or more embodiments may be the tester of the aspect 37, wherein each of the first acquirers may comprise an acquiring unit that acquires the first signal from the first temperature detecting circuit using a test program that executes a test of the DUT.

An aspect 39 of one or more embodiments may be the tester of any one of the aspects 37 to 38, wherein each of the first acquirers may generate the second signals using the first signal.

An aspect 40 of one or more embodiments may be the tester of any one of the aspects 37 to 39, wherein the first signal outputted from the first temperature detecting circuit may be a first digital signal.

An aspect 41 of one or more embodiments may be the tester of any one of the aspects 37 to 40, wherein each of the first temperature detecting circuits may comprise: a measuring unit that measures the internal temperature of the DUT; and a calibrating unit that calibrates a measurement result of the measuring unit, and the first temperature detecting circuit may output the measurement result calibrated by the calibrating unit as the first signal to the first acquirer.

An aspect 42 of one or more embodiments may be the tester of any one of the aspects 37 to 41, wherein the first temperature detecting circuits are disposed apart from each other in a plan view of the DUT.

An aspect 43 of one or more embodiments is a device testing apparatus that tests a device under test (DUT) electrically connected to a socket or the DUT contained in a carrier electrically connected to the socket, the DUT including first temperature detecting circuits, the device testing apparatus comprising: the temperature adjusting system of any one of the aspects 1 to 20.

An aspect 44 of one or more embodiments is a device testing apparatus that tests a device under test (DUT) including first temperature detecting circuits, the device testing apparatus comprising: a temperature adjuster that adjusts a temperature of the DUT; the controller of any one of the aspects 21 to 30; and the tester of any one of the aspects 37 to 42.

An aspect 45 of one or more embodiments is a device testing apparatus that tests a device under test (DUT) including first temperature detecting circuits, the device testing apparatus comprising: the device handling apparatus of any one of the aspects 31 to 36; and the tester of any one of the aspects 37 to 42.

According to one or more embodiments, each of the first acquirers acquires the first signal and outputs the second signal, the first signal is outputted from the first temperature detecting circuit and indicates an internal temperature of the DUT, and the controller controls the temperature adjuster using the second signals. Therefore, it is possible to improve the accuracy of temperature adjustment.

### BRIEF DESCRIPTION OF THE DRAWINGS

FIG. 1 is a schematic cross-sectional view showing the overall configuration of the device testing apparatus in one or more embodiments;

FIG. 2 is a diagram for explaining the transmission and reception of signals between the DUT, the tester, and the handler in one or more embodiments;

FIG. 3 is a plan view showing the arrangement of the thermal diode and the DTSs in the DUT in one or more embodiments;

FIG. 4 is a flowchart showing an example of the test program in one or more embodiments;

FIG. 5 is a block diagram showing the overall configuration of the temperature adjusting system in one or more embodiments;

FIG. 6 is a block diagram showing details of the first acquirer shown in FIG. 5;

FIG. 7 is a fluid circuit diagram showing the configuration of the temperature adjuster in one or more embodiments;

FIG. 8 is a cross-sectional view showing the configurations of the contact arm and the carrier in one or more embodiments; and

FIG. 9 is a block diagram showing a modification of the controller in one or more embodiments.

### DESCRIPTION OF THE EMBODIMENTS

Hereinafter, embodiments will be described with reference to the drawings.

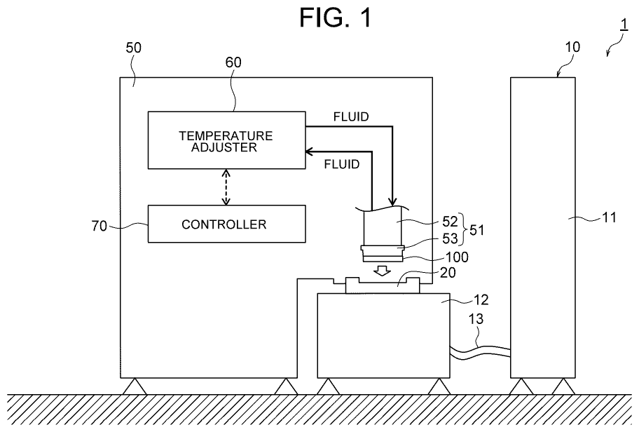

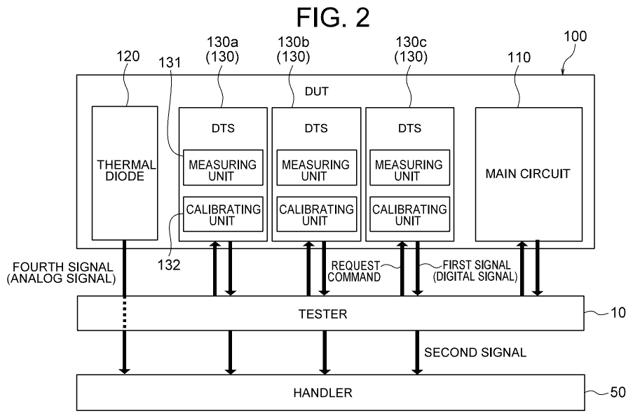

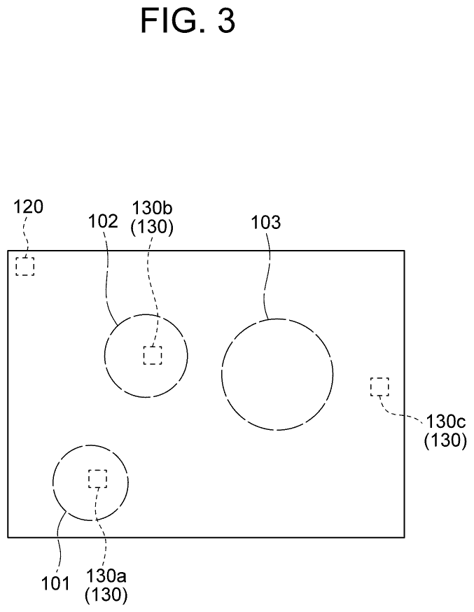

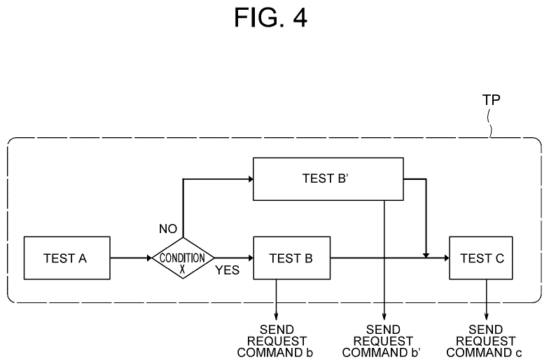

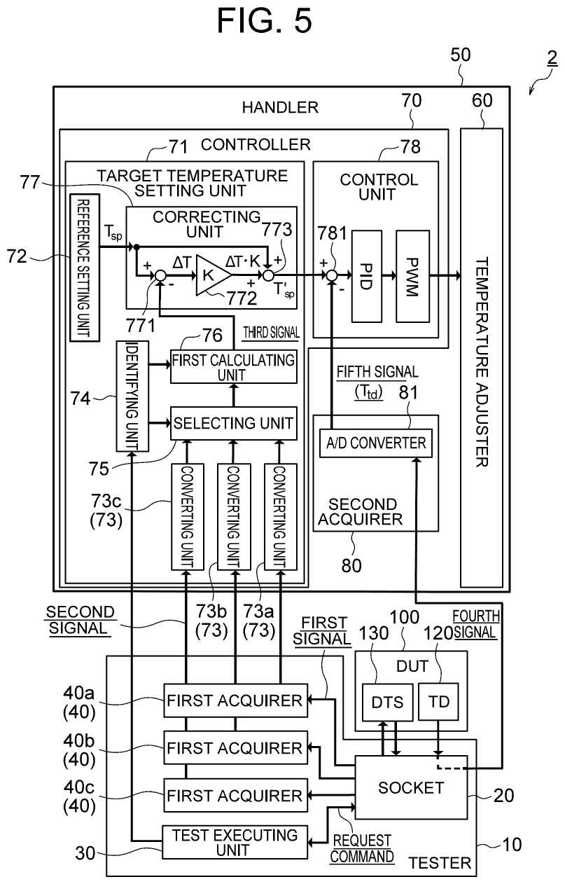

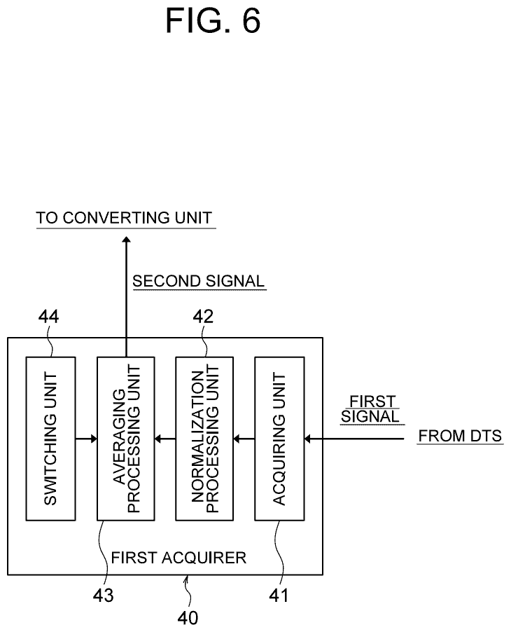

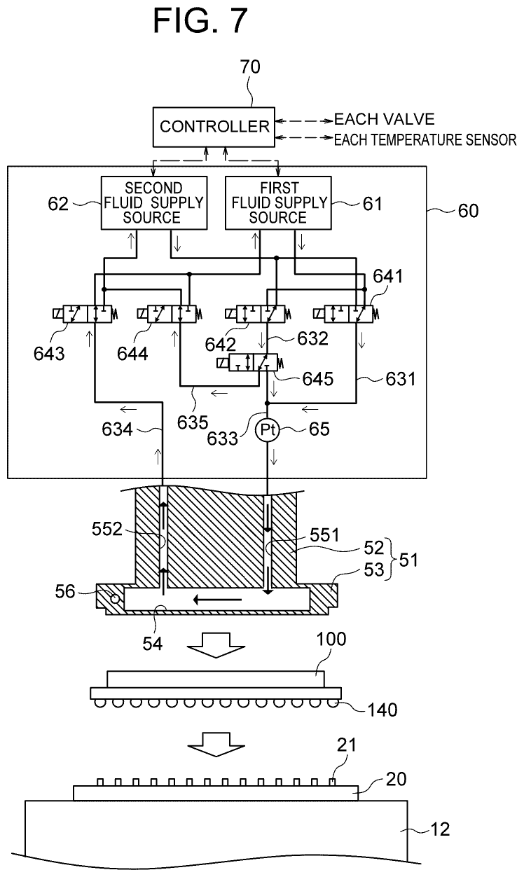

FIG. 1 is a schematic cross-sectional view showing the overall configuration of the device testing apparatus 1 in one or more embodiments, FIG. 2 is a diagram for explaining the transmission and reception of signals between the DUT 100, the tester 10, and the handler 50 in one or more embodiments, FIG. 3 is a plan view showing the arrangement of the thermal diode 120 and the DTSs 130a to 130c in the DUT 100 in one or more embodiments, FIG. 4 is a flowchart showing an example of the test program (test instructions) TP in one or more embodiments, FIG. 5 is a block diagram showing the overall configuration of the temperature adjusting system 2 in one or more embodiments, and FIG. 6 is a block diagram showing details of the first acquirer 40 shown in FIG. 5, and FIG. 7 is a fluid circuit diagram showing the configuration of the temperature adjuster 60 in one or more embodiments.

The device testing apparatus 1 shown in FIG. 1 is an apparatus that tests the electrical characteristics of the DUT 100 such as a semiconductor integrated circuit element. The device testing apparatus 1 tests whether or not the DUT 100 operates appropriately while applying high or low temperature thermal stress to the DUT 100.

The device testing apparatus 1 includes a tester 10 and a handler 50. The tester 10 performs tests to measure and evaluate the electrical characteristics of the DUT 100. The tester 10 includes a main frame 11 and a test head 12. The test head 12 is connected to the main frame 11 via a cable 13. A socket 20 is mounted on the upper part of the test head 12, and the socket 20 and the test head 12 are electrically connected to each other.

The handler 50 presses the DUT 100 against the socket 20 to electrically connect the DUT 100 and the socket 20. As a result, the DUT 100 and the test head 12 are electrically connected via the socket 20. The main frame 11 is, for example, a computer that executes a program, and the main frame 11 communicates with and controls the test modules (not shown) in the test head 12 according to the program. The test module is a wiring board on which electronic devices such as test devices used for testing the DUT 100 are mounted. Each of the test modules generates test signals according to instructions from the main frame 11 and inputs the test signals to the DUT 100. Then, the tester 10 measures and evaluates the output of the DUT 100 corresponding to the input signal.

Although not particularly limited, the DUT 100 is, for example, a semiconductor device. A specific example of the DUT 100 includes a SoC (System on a chip). The DUT 100 may be a semiconductor device other than the SoC, such as a logic device or a memory device. The DUT 100 may be a resin molded device in which a semiconductor chip is packaged with a molding material such as a resin material, or the DUT 100 may be a bare die that is not packaged. When the kind of DUT 100 is changed, the socket 20 is replaced with one that corresponds to the shape, number of pins, etc. of the DUT 100.

As shown in FIG. 2, the DUT 100 includes, in addition to the main circuit 110 to be tested, one thermal diode 120 and a plurality of (three in one or more embodiments) DTSs (Digital Temperature detecting Sensor) 130a to 130c. The thermal diode 120 and the DTSs 130a to 130c are formed on a semiconductor substrate together with the main circuit 110 using a semiconductor manufacturing technique such as photolithography. The three DTSs 130a to 130c have the same configuration, and the DTSs 130a to 130c are collectively referred to as “DTS 130” in one or more embodiments.

As shown in FIG. 3, the thermal diode 120 and the plurality of DTSs 130a to 130c are arranged at mutually different positions in the DUT 100. Specifically, the plurality of DTSs 130a to 130c are arranged apart from one another in the DUT 100. The thermal diode 120 is also arranged apart from all the DTSs 130a to 130c in the DUT 100. Therefore, as shown in FIG. 3, when the DUT 100 is seen through from above, the thermal diode 120 and the plurality of DTSs 130a to 130c are distributed apart from one another in the DUT 100.

The number of thermal diodes 120 included in the DUT 100 is not particularly limited to the above, and for example, the DUT 100 may include a plurality of thermal diodes 120. Alternatively, the DUT 100 may not include a thermal diode 120. Further, the number of DTSs 130 included in the DUT 100 is not limited to the above, and the DUT 100 may include two or four or more DTSs 130. The arrangement of the thermal diode 120 and DTSs 130 in the DUT 100 shown in FIG. 3 is merely one example.

The thermal diode 120 is an analog-type temperature detecting circuit that outputs a fourth signal indicating the inner temperature of DUT100. The fourth signal outputted from the thermal diode 120 is an analog signal. The thermal diode 120 corresponds to an example of the “second temperature detecting circuit” in the aspect of one or more embodiments. Instead of the thermal diode 120, the DUT 100 may include an element having resistive characteristic or bandgap characteristic depending on the temperature as the analog-type temperature detecting circuit. Alternatively, instead of the thermal diode 120, a thermocouple may be embedded in DUT100 as the second temperature detecting circuit.

On the other hand, the DTS 130 is a digital-type temperature detecting circuit that outputs a first signal indicating the inner temperature of DUT100. The first signal outputted from the DTS 130 is a digital signal. As shown FIG. 2, the DTS 130 includes a measuring unit 131 and a calibrating unit 132 that calibrates the measurement result of the measuring unit 131. The measuring unit 131 is a circuit that measures the internal temperature of the DUT 100. Although not particularly limited, the measuring unit 131 includes an analog temperature sensor and an A/D converter that converts the measurement result of the temperature sensor into a digital signal. The calibrating unit 132 is a circuit that calibrates the measurement result of the measuring unit 131. The DTS 130 is capable of outputting the measurement result calibrated by the calibrating unit 132 to the tester 10 as the first signal. The DTS 130 corresponds to an example of the “first temperature detecting circuit” in the aspect of one or more embodiments.

As compared with the thermal diode 120, since the DTS 130 is located closer to the main circuit 110, it is possible to measure the temperature of the DUT100 with higher accuracy. The output of the DTS 130 is calibrated with high accuracy in the front-end process test, and the calibrating unit 132 calibrates the measurement result of the measuring unit 131 based on the calibration data. Therefore, it is possible to detect the temperature of the DUT 100 with higher accuracy.

As described above, since the output of the DTS 130 is a digital signal, the DTS 130 is also electrically connected to terminals 140 (see FIG. 7) of the DUT 100 that are electrically connected to the main circuit 110. Therefore, as shown in FIG. 2 and FIG. 4, it is possible to acquire the first signal from the DTS 130 via the socket 20 to which the terminals 140 are electrically connected using the test program TP performed by the tester 10. On the other hand, since the output of the thermal diode 120 is an analog signal, the dedicated terminal 140 is assigned to the thermal diode 120. Although not particularly limited, a specific example of the DUT 100 including the DTS 130 includes a device provided by Synopsys, Inc.

As shown in FIG. 5, the tester 10 includes a test executing unit 30 and a plurality of (three in one or more embodiments) first acquirers 40a to 40c. The test executing unit 30 executes a test of the DUT 100 using the test program TP. The plurality of first acquirers 40a to 40c respectively acquire the first signals from the DTSs 130a to 130c and respectively use the first signals to generate the second signals for controlling the temperature adjuster 60 described later. The first acquirer 40a acquires the first signal from the DTS 130a, the first acquirer 40b acquires the first signal from the DTS 130b, and the first acquirer 40c acquires the first signal from the DTS 130c.

The three first acquirers 40a to 40c have the same configuration, and the first acquirer 40a to 40c are collectively referred to as the “first acquirer 40” in one or more embodiments. The number of first acquirers 40 included in the tester 10 is not particularly limited to the above, and it can be set according to the number of DTSs 130 included in the DUT 100.

The test executing unit 30 and the first acquirers 40a to 40c are functionally realized by, for example, a computer. Although not particularly shown, the computer is an electronic computer including a CPU (processor), a main storage device (such as a RAM), a secondary storage device (such as a hard disk and a SSD), interfaces, and the like. The computer can functionally realize the test executing unit 30 and the first acquirers 40a to 40c by reading and executing a program stored in the secondary storage device.

The first acquirer 40 generates a second signal using the first signal outputted from the DTS 130. As shown FIG. 6, each of the first acquirers 40 includes an acquiring unit 41, a normalization processing unit 42, an averaging processing unit 43, and a switching unit 44. The first acquirers 40 may not include at least one of the normalization processing unit 42, the averaging processing unit 43 and the switching unit 44. When the first acquirers 40 does not include the normalization processing unit 42, the averaging processing unit 43 and the switching unit 44, the first acquirers 40 directly outputs the first signal outputted from the DTS 130 as the second signal.

The acquiring unit 41 acquires the first signal from the DTS 130 using the test program TP executed by the tester 10 and outputs the first signal to the normalization processing unit 42. In this way, by acquiring the first signal using the test program TP, the acquiring unit 41 can acquire the internal temperature of the DUT 100 during the test of the DUT 100, and it is possible to detect the temperature with higher accuracy.

Specifically, as shown in FIG. 2, FIG. 4, and FIG. 5, first, the test executing unit 30 transmits a request command written in the test program TP to the DUT 100. The request command is a signal requesting the DTS 130 to output the first signal. Based on the request command, the DTS 130 measures the internal temperature of the DUT 100 by the measuring unit 131, calibrates the measurement result by the calibrating unit 132, and then sends the first signal to the acquiring unit 41.

The test executing unit 30 sends the request command at a required time in the test program TP in a pinpoint manner. Although not particularly limited, the test executing unit 30 sends the request commands to the DUT 100 at uneven intervals of, for example, ten seconds to several hundred seconds. Although not particularly limited, more specifically, the uneven intervals at which the test executing unit 30 sends the request commands are 10 seconds or more or 100 seconds or more.

Here, since the test program generally includes a branch and the test to be executed varies in accordance with the branch, the timing (the elapsed time from the start of the test) at which the request command is sent from the test program to the DUT is irregular rather than constant period. This point will be described in detail with reference to an example shown in FIG. 4.

The test program TP shown in FIG. 4 includes a test A, a test B, a test B′, and a test B′, and a test C, and either of the test B and the test B′ is selectively executed based on a condition X. That is, the test program (main program) TP of one or more embodiments includes a plurality of tests (for example, each corresponding to a test suite in which a sub-program for executing individual test is described) each of which has a different test content.

In the example shown in FIG. 4, since the description position of the request command b in the test B is different from the description position of the request command b′ in the test B′, the timing of sending the request command b in the test B is different from the timing of sending the request command b′ in the test B′. Further, since the test time of the test B is different from the test time of the test B′, the timing at which the request command c is sending in the test C is also changed depending on whether the test B or the test B′ is selected at the condition X. In this way, since the test program TP includes the branch (the condition X), the timing at which the acquiring unit 41 acquires the first signal from the DTS 130 is unpredictable and irregular.

The test program TP shown in FIG. 4 is merely an example, and for example, the number of tests and the number of conditions included in the test program can be arbitrarily set. Further, the types of each test and the order in which the tests are executed are not particularly limited and it can be set arbitrarily. Although not particularly limited, specific examples of such tests include the contact test, the function test, the DC test, the scan test, the power supply current test (power consumption test), and the like. The test program is configured by combining the plurality of types of tests and it is configured to execute the tests in sequence.

The request command can be written in any test after the contact test. Although one request command b, b′ or c is sent in each of the test B, B′ and C in the example shown in FIG. 4, it is not particularly limited thereto, and the test program may include a test that does not send the request command. One test may have a plurality of request commands. The test program may include request commands written between tests.

The normalization processing unit 42 shown in FIG. 6 executes normalization processing (data cleansing processing) on the first signal acquired by the acquiring unit 41.

First, the normalization processing unit 42 determines whether the first signal is normal or abnormal. That is, the normalization processing unit 42 first determines the reliability of the first signal. Although not particularly limited, specifically, the normalization processing unit 42 determines whether the first signal is normal or abnormal, for example, by determining whether or not the absolute value of the internal temperature of the DUT 100 indicated by the first signal is within a predetermined range.

Alternatively, the normalization processing unit 42 may determine whether the first signal is normal or abnormal by determining whether the change amount of the first signal is within a predetermined range. Specifically, in this case, the normalization processing unit 42 stores the previous first signal acquired last time by the acquiring unit 41. Then, the normalization processing unit 42 calculates the change amount between the value of the previous first signal and the value of the current first signal acquired this time by the acquiring unit 41. Then, the normalization processing unit 42 determines whether the first signal is normal or abnormal by determining whether or not the change amount is within a predetermined range. Alternatively, instead of the change amount described above, Bollinger bands calculated based on a plurality of past first signals of a plurality of past times may be used.

Then, when the normalization processing unit 42 determines that the first signal is normal, the normalization processing unit 42 outputs the first signal to the averaging processing unit 43. On the other hand, when the normalization processing unit 42 determines that the first signal is abnormal, the normalization processing unit 42 outputs, as the first signal, a value (a normal value within a predetermined range) different from the current first signal to the averaging processing unit 43. Although not particularly limited, when the normalization processing unit 42 determines that the first signal is abnormal, for example, the normalization processing unit 42 outputs, instead of the current first signal, the previous first signal that is determined to be the normal by the normalization processing unit 42 last time to the averaging processing unit 43.

Alternatively, the normalization processing unit 42 stores the past first signal determined to be normal by the normalization processing unit 42, and when the normalization processing unit 42 determines that the first digital is abnormal, a moving average of the current first signal and the past first signal may be calculated, and the calculation result may be outputted to the averaging processing unit 43. This past first signal may be only the previous first signal or may be a plurality of past first signals of a plurality of past times.

Alternatively, the normalization processing unit 42 may acquire and store the reference value Tsp set in the reference setting unit 72 of the handler 50 described later from the reference setting unit 72, and the normalization processing unit 42 may output the reference value Tsp as it is to the averaging processing unit 43 when the normalization processing unit 42 determines that the first signal is abnormal.

Since the normal first signal can be outputted to the handler 50 by the normalization processing even when the first signal is an abnormal value or the first signal is missing due to mis-contact or communication failure between the DUT 100 and the socket 20, it is possible to stabilize the control of the temperature adjuster 60 by the controller 70.

The averaging processing unit 43 executes averaging processing on the first signal outputted from the normalization processing unit 42 and outputs the calculation result as the second signal to the converting unit 73 of the handler 50. As described above, since the first signal is irregularly acquired from the DTS 130 by the acquiring unit 41, this second signal is also irregularly outputted from the averaging processing unit 43 to the converting unit 73 of the handler 50. The tester 10 and the handler 50 are connected via a cable (not shown), and signals and data can be exchanged between the tester 10 and the handler 50 through GBIP communication. The tester 10 and the handler 50 may be connected via LAN.

Although not particularly limited, the following process can be exemplified as a specific example of the averaging processing. For example, the averaging processing unit 43 stores the past first signal outputted from the normalization processing unit 42 and calculates the moving average of the current first signal and the past first signal. This past first signal may be only the previous first signal or may be a plurality of past first signals of a plurality of past times. By executing such averaging processing on the first signal, it is possible to reduce the noise contained in the first signal to improve accuracy and to reduce the amount of data communication between the tester 10 and the handler 50.

The plurality of first signals averaged by the averaging processing unit 43 may be acquired by the acquiring unit 41 with a plurality of request commands during the same test, may be acquired by the acquiring unit 41 with a plurality of request commands across a plurality of tests, or may be a mixture of these. The averaging processing executed by the averaging processing unit 43 is not particularly limited to the above as long as it can improve accuracy and reduce the amount of data communication.

The switching unit 44 enables or disables the averaging processing unit 43. That is, the switching unit 44 switches between enabling and disabling the averaging processing executed by the averaging processing unit 43 on the first signal.

Specifically, when the switching unit 44 enables the averaging processing unit 43, the averaging processing unit 43 executes the above-mentioned averaging processing on the first signal outputted from the normalization processing unit 42. On the other hand, when the switching unit 44 disables the averaging processing unit 43, the averaging processing unit 43 outputs the first signal as it is as the second signal to the converting unit 73 of the handler 50 without executing the averaging processing on the first signal outputted from the normalizing processing unit 42.

The switching unit 44 may enable or disable the normalization processing unit 42. Specifically, when the switching unit 44 enables the normalization processing unit 42, the normalization processing unit 42 executes the above-mentioned normalization processing on the first signal outputted from the acquiring unit 41. On the other hand, when the switching unit 44 disables the normalization processing unit 42, the normalization processing unit 42 outputs the first signal as it is to the averaging processing unit 43 without executing the normalization processing on the first signal outputted from the acquiring unit 41.

Alternatively, the switching unit 44 may enable or disable the averaging processing unit 43 and also enable or disable the normalization processing unit 42. When the switching unit 44 enables both the normalization processing unit 42 and the averaging processing unit 43, the first signal on which both the normalization processing and the averaging processing are executed is outputted as the second signal to the converting unit 73 of the handler 50. On the other hand, when the switching unit 44 enables the normalization processing unit 42 and disables the averaging processing unit 43, the first signal on which only the normalization processing is executed is outputted as the second signal to the converting unit 73 of the handler 50. When the switching unit 44 disables the normalization processing unit 42 and enables the averaging processing unit 43, the first signal on which only the averaging processing is executed is outputted as the second signal to the converting unit 73 of the handler 50. When the switching unit 44 disables both the normalization processing unit 42 and the averaging processing unit 43, neither the normalization processing nor the averaging processing is executed, and the first signal acquired by the acquiring unit 41 is outputted as it is as the second signal to the converting unit 73 of the handler 50.

The operator of the device testing apparatus 1 can select enabling or disabling of the averaging processing unit 43 and the normalization processing unit 42 by operating the switching unit 44 in accordance with the reliability of the first signal and the amount of data communication.

As shown FIG. 1, the handler 50 transports and presses the DUT 100 to the socket 20. The handler 40 includes a contact arm 51, a temperature adjuster 60, a controller 70, and a second acquirer 80 (see FIG. 5).

The contact arm 51 includes an arm body 52 and a pusher 53. The arm body 52 includes an actuator (not shown) for horizontal movement and is capable of moving in the front, back, left, and right direction. The arm body 52 also includes an actuator (not shown) for vertical movement and is capable of moving in the up and down direction. The pusher 53 is disposed at the distal end of the arm body 52. The pusher 53 is capable of holding the DUT 100 by vacuum-suction or the like.

An upper part of the test head 12 enters the handler 50 through an opening, and the socket 20 is located in the handler 50. The DUT 100 is transported above the socket 20 located in the handler 50 by the arm body 52 horizontally moving while holding the DUT 100 by the pusher 53. Next, the DUT 100 is pressed against the socket 20 by the arm body 52 lowering.

As shown FIG. 7, an inner space 54 is formed in the pusher 53 of the contact arm 51. Flow paths 551 and 552 formed in the arm body 52 communicate with the inner space 54, and the inner space 54 is connected to the temperature adjuster 60 via the flow paths 551 and 552. A temperature sensor 56 that detects the temperature of the DUT 100 is embedded in the pusher 53. The temperature sensor 56 is connected to the controller 70 so that the detection result can be transmitted to the controller 70. Although the DUT 100 is illustrated as being separated from the pusher 53 in FIG. 7 for convenience of explanation, the DUT 10 is in contact with the pusher 53 since the DUT 100 is actually held by the contact arm 51.

The temperature adjuster 60 is a device which adjusts the temperature of the DUT 100 so that a high-temperature test or a low-temperature test of the DUT 100 can be performed and the self-heating of the DUT 100 is offset. The temperature adjuster 60 is a two-liquid mixing type temperature adjusting device that mixes a heating liquid and a cooling liquid at an arbitrary ratio and supplies the mixture to the pusher. As the temperature adjuster 60, a device disclosed in US 2019/302178 A or US 2015/0268295 A can be used. Specifically, as shown in FIG. 7, the temperature adjuster 60 includes a first fluid supply source 61, a second fluid supply source 62, first to fifth flow passages 631 to 635, first to fourth switches 641 to 644, a flow rate regulator 645, and a temperature sensor 65.

The first fluid supply source 61 adjusts the temperature of the first fluid to the first temperature and supplies the first fluid to the first flow passage 631 or the second flow passage 632. Meanwhile, the second fluid supply source 62 adjusts the temperature of the second fluid to the second temperature and supplies the second fluid to the second flow passage 632 or the first flow passage 631. The first and second temperatures are different temperatures. For example, the first temperature is a temperature lower than the second temperature. In this case, the first fluid serves as a cold medium, and the second fluid serves as a hot medium. As specific examples of the first and second fluids, brine of a fluorine-based inert solution can be exemplified.

The first switch 641 switches a supply source to the first flow passage 631 to the first or second fluid supply source 61 or 62. Meanwhile, the second switch 642 switches a supply source to the second flow passage 632 to the second or first fluid supply source 62 or 61. The flow rate regulator 645 is disposed in the second flow passage 632 and adjusts the flow rate of the fluid led from the second flow passage 632 to the third flow passage 633. As specific examples of the first and second switches 641 and 642 and the flow rate regulator 645, a three-port valve can be exemplified.

The third flow passage 633 communicates with the inlet side flow passage 551 of the arm body 52, and a mixed fluid flows in the inner space 54 of the pusher 53. At this time, since heat is exchanged between the mixed fluid and the pusher 53, the DUT 100 is heated or cooled.

The fourth flow passage 634 is connected to the outlet side flow passage 552 of the arm body 52. The used mixed fluid is discharged from the inner space 54 of the pusher 53. The third switch 643 switches a connection target of the fourth flow passage 634 to the first or second fluid supply source 61 or 62. Meanwhile, the fluid which is not led to the third flow passage 633 is discharged from the flow rate regulator 645 to the fifth flow passage 635. The fourth switch 644 switches a connection target of the fifth flow passage 635 to the second or first fluid supply source 62 or 61. As specific examples of the third and fourth switches 643 and 644, a three-port valve can be exemplified.

The temperature sensor 65 is disposed in the third flow passage 633. The temperature sensor 65 is connected to the controller 70 so that the temperature sensor 65 can output the detection result to the controller 70.

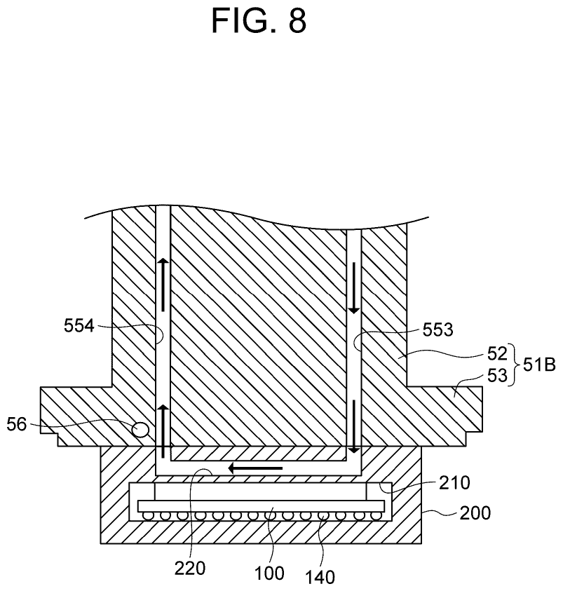

Instead of the above-mentioned method (pusher cooling method) in which the temperature of the DUT 100 is adjusted via the pusher 53, a method (carrier cooling method) in which the temperature of the DUT 100 is adjusted via a pusher 53 and a carrier 200 as shown in FIG. 8 may also be used. FIG. 8 is a cross-sectional view showing the configurations of the contact arm 51B and the carrier 200 in another example of one or more embodiments.

In the example shown in FIG. 8, the contact arm 51B holds the carrier 200 that accommodates the DUT 100 in the accommodating part 210, and the DUT 100 and the socket 20 are electrically connected via the carrier 200 by pressed the carrier 200 against the socket 20. A flow passage 220 through which fluid passes is formed in the carrier 200. Although not particularly limited, for example, a carrier described in JP2023-16503A can be used as the carrier 200.

In the example shown in FIG. 8, flow passages 553 and 554 are formed in the contact arm 51B. The flow passage 553 is connected to the above-described third flow passage 633 of the temperature adjuster 60, and fluid whose temperature is adjusted by the temperature adjuster 60 is continuously supplied to the flow passage 553. Further, the flow passages 553 and 554 are open at the front-end surface of the pusher 53 so as to face the inlet and outlet of the flow passage 220 of the carrier 200, and the flow passages 553 and 554 of the contact arm 51B communicate with the flow passage 220 of the carrier 200 in a state in which the contact arm 51B holds the carrier 200. Therefore, the fluid supplied to the flow passage 553 of the contact arm 51B enters the flow passage 220 of the carrier 200 and exchanges heat with the DUT 100 to adjust the temperature of the DUT 100. The flow passage 554 of the contact arm 51B is connected to the above-described fourth flow passage 634 of the temperature adjuster 60, and the fluid passed through the flow passage 220 is discharged to the flow passage 554 and collected to temperature adjuster 60.

Alternatively, although not particularly shown, instead of the contact arm 51, the handler 50 may be of a type that presses the DUT 100 contained the test tray against the socket 20 by the Z driving device. In this case, the above-described inner space 54 is formed in a pusher attached to the Z driving device.

Alternatively, although not particularly shown, instead of the pusher cooling method, a socket cooling method in which a fluid is supplied into the socket 20 to adjust the temperature of the DUT 100 may be used.

Alternatively, instead of the above-described two-liquid mixing type temperature adjuster 60, other temperature adjusting devices including a gas mixing method, a chamber method, a hot plate method, and a Peltier method may be used as a temperature adjuster that adjusts the temperature of the DUT 100.

The gas mixing method is a method in which a mixed fluid formed by mixing a gas (nitrogen or air) that is continuously supplied and whose temperature is adjusted by a heater and air at room temperature intermittently supplied is supplied to a socket. Although not particularly limited, the gas mixing method is, for example, a method as described in WO2023/084612 and WO2023/084613.

The chamber method is a method in which the temperature of the DUT is adjusted by controlling the atmosphere temperature in the chamber using a heater and nitrogen gas. The hot plate method is a method in which the temperature of the DUT is adjusted by placing the DUT on a plate and heating the plate. The Peltier method is a method in which the temperature of the DUT is adjusted by heating or cooling a Peltier element that is in thermally contacted with the DUT.

As shown in FIG. 1 and FIG. 5, the controller 70 controls the above-described temperature adjuster 60 using the plurality of second signals outputted from the plurality of first acquirers 40a to 40c. Specifically, the controller 70 controls the first and second fluid supply sources 61 and 62, the first to fourth switches 641 to 644, and the flow rate regulator 645 of the temperature adjuster 60.

As shown FIG. 5, the controller 70 of one or more embodiments includes a target temperature setting unit 71 and a control unit 78 in order to control the temperature adjuster 60. The controller 70 adjusts the temperature of the fluid supplied from the temperature adjuster 60 to the inner space 54 of the pusher 53 by controlling the temperature adjuster 60 using the plurality of second signal outputted from the plurality of first acquirers 40a to 40c of the tester 10.

The controller 70 of one or more embodiments is functionally realized by, for example, a computer that controls the handler 50. Although not particularly shown, the computer is an electronic computer including a CPU (processor), a main storage device (such as a RAM), a secondary storage device (such as a hard disk and a SSD), interfaces, and the like. The computer can functionally realize the target temperature setting unit 71 and the control unit 78 by reading and executing a program stored in the secondary storage device.

As shown in FIG. 5, the target temperature setting unit 71 sets the target temperature Tsp′ using the plurality of second signals outputted from the tester 10. The target temperature setting unit 71 includes a reference setting unit 72, a plurality of (three in one or more embodiments) converting units 73a to 73c, an identifying unit 74, a selecting unit 75, a calculating unit 76, and a correcting unit 77. The method for setting the target temperature Tsp′ by the target temperature setting unit 71 is not particularly limited to the method described below.

The three conversing units 73a to 73c have the same configuration, and the conversing units 73a to 73c are collectively referred to as the “conversing unit 73” in one or more embodiments. The first acquirers 40a to 40c are respectively connected to the conversing units 73a to 73c, and the first acquirer 40a outputs the second signal to the conversing unit 73a, the first acquirer 40b outputs the second signal to the conversing unit 73b, and the first acquirer 40c outputs the second signal to the conversing unit 73c. The number of conversing units 73 included in the target temperature setting unit 71 is not particularly limited to the above, and it can be set according to the number of first acquirers 40 included in the tester 10.

The reference setting unit 72 stores a reference value (reference temperature) Tsp that is the original (initial) target temperature of the DUT 100 at the time of the test, and the reference value Tsp is outputted from the reference setting unit 72 to the correcting unit 77. The reference value Tsp is set in the reference setting unit 72, for example, by being inputted into the controller 70 via an input device by an operator of the device testing apparatus 1.

On the other hand, the second signal is inputted to each converting unit (the synchronizing unit) 73 from the first acquirer 40 of the tester 10 described above. As described above, the second signal is irregularly (not periodically) outputted from the first acquirer 40. Therefore, the converting unit 73 converts the second signal from an irregular signal (not periodical signal/asynchronous signal) to a regular signal (periodical signal/synchronous signal), and the converted second signal is sent to the selecting unit 75. Both the reference value Tsp and the fifth signal Ttd described later are regular signals (periodical signals), and the second signal is converted into a regular signal (periodical signal/synchronization signal) synchronized with these regular signals (periodical signals) Tsp and Ttd.

Specifically, upon receiving the second signal from the first acquirer 40, the converting unit 73 stores the second signal in the storage unit and outputs this second signal to the selecting unit 75 at regular time intervals. Then, when a new second signal is received from the first acquirer 40, the second signal stored in the storage unit is updated, and the updated second signal is outputted to the selecting unit 75 at regular time intervals. The converting unit 73 may convert the second signal from an irregular signal to a regular signal by using a Kalman filter.

As described above, in one or more embodiments, since the second signal is converted from an irregular signal to a regular signal by the converting unit 73, it is possible to stably control the temperature adjuster 60 by the controller 70 even if the timing at which the acquiring unit 41 acquires the first signal is irregular (not periodical) due to branching of the test program because of acquiring the first signal during the test.

A correspondence between the names of individual tests (for example, “Test A,” “Test B,” “Test B′,” and “Test C” shown in FIG. 4) in the test program and the driving portions of the DUT 100 are stored in advance in the identifying unit 74. As specifically explained using the examples shown in FIG. 3 and FIG. 4, the portion 101 is associated with the portion of the DUT 100 that is driven and generates heat when the test B is executed. Similarly, the portion 102 is associated with the portion that is driven and generates heat when the test B′ is executed, and the portion 103 is associated with the portion that is driven and generates heat when the test C is executed.

As shown in FIG. 5, the test executing unit 30 of the tester 10 is connected to the identifying unit 74, and the identifying unit 74 is capable of acquiring the name of the test being executed on the DUT 100 from the test executing unit 30. Then, the identifying unit 74 identifies the portion of the DUT 100 that is generating heat due to the execution of that test based on the test name acquired from the test executing unit 30.

As specifically explained using the examples shown in FIG. 3 and FIG. 4, when the test being performed is “Test B”, the identifying unit 74 identifies the portion 101 as the heat generating portion of the DUT 100. On the other hand, when the test being performed is “Test B”, the identifying unit 74 identifies the portion 102 as the heat generating portion of the DUT 100, and when the test being performed is “Test C”, the identifying unit 74 identifies the portion 103 as the heat generating portion of the DUT 100. Then, the identifying unit 74 outputs the heat generating portion identified based on the test name to the selecting unit 75 and the first calculating unit 76.

A positional relationship between the heat generating portions 101 to 103 and the DTSs 130a to 130c in the DUT 100 are stored in advance in the selecting unit 75. The selecting unit 75 then selects one or more second signals from among the plurality of second signals outputted from the conversing units 73a to 73c based on the heat generating portion identified by the identifying unit 74.

For example, when one DTS 130 is included in the heat generating portion identified by the identifying unit 74, the selecting unit 75 selects one second signal from the plurality of second signals outputted from the conversing units 73a to 73c. The one second signal selected by the selecting unit 75 is the second signal generated using the detection result of the DTS 130 included in the heat generating portion.

As specifically explained using the examples shown in FIG. 3 and FIG. 4, when the identifying unit 74 identifies the portion 101 as the heat generating portion, the selecting unit 75 outputs only the second signal using the detection result of the DTS 130a (i.e., the second signal from the conversing unit 73a) to the first calculating unit 76 and does not output the second signals using the detection results of the DTSs 130b and 130c (i.e., the second signals from the conversing units 73b and 73c) to the first calculating unit 76. On the other hand, when the identifying unit 74 identifies the portion 102 as the heat generating portion, the selecting unit 75 outputs only the second signal using the detection result of the DTS 130b (i.e., the second signal from the conversing unit 73b) to the first calculating unit 76 and does not output the second signals using the detection results of the DTSs 130a and 130c (i.e., the second signals from the conversing units 73a and 73c) to the first calculating unit 76.

On the other hand, when there is no DTS 130 included in the heat generating portion identified by the identifying unit 74, the selecting unit 75 selects two second signals from the plurality of second signals outputted from the conversing units 73a to 73c. The two selected second signals are signals generated using the detection results of two DTSs 130 close to the heat generating portion.

As specifically explained using the examples shown in FIG. 3 and FIG. 4, when the identifying unit 74 identifies the portion 103 as a heat generating portion, the selecting unit 75 outputs two second signals using the detection results of the two DTSs 130b and 130c close to the portion 103 (i.e., two second signals from the conversing units 73b and 73c) to the first calculating unit 76 and does not output the second signal using the detection result of the DTS 130a (i.e., the second signal from the conversing unit 73a) to the first calculating unit 76. The number of second signals selected by the selecting unit 75 is not particularly limited to the above, and for example, the selecting unit 75 may select three or more second signals generated using the detection results of three or more DTSs 130 close to the heat generating portion.

The positional relationship between the heat generating portions 101 to 103 and the DTSs 130a to 130c in the DUT 100 are also stored in advance in the first calculating unit 76. When the plurality of second signals are inputted from the selecting unit 75, the first calculating unit 76 calculates the internal temperature of the DUT 100 corresponding to the heat generating portion from the plurality of second signals using, for example, the interpolation method.

As specifically explained using the examples shown in FIG. 3 and FIG. 4, when the identifying unit 74 identifies the portion 103 as the heat generating portion, the first calculating unit 76 calculates the internal temperature of the DUT 100 corresponding to the heat generating portion 103 from the two second signals output from the selecting unit 75, for example by using the interpolation method, based on the positional relationship between the heat generating portion 103 and the two DTSs 130b and 130c.

Then, the first calculating unit 76 outputs the calculation result as a third signal to the correcting unit 77. On the other hand, when only one second signal is inputted from the selecting unit 75, the first calculating unit 76 outputs the second signal as it is as the third signal to the correcting unit 77 without performing any particular calculation. The first calculating unit 76 corresponds to an example of the “calculating unit” in the aspect of one or more embodiments.

The target temperature setting unit 71 may not include the selecting unit 75. In this case, the plurality of second signals are directly outputted from the plurality of converting units 73a to 73b to the first calculating unit 76. Then, the first calculating unit 76 calculates the internal temperature of the DUT 100 corresponding to the heat generation portion identified by the identifying unit 74 from the plurality of second signals outputted from the plurality of converting units 73a to 73b based on the positional relationship between the heat generating portions and the plurality of DTSs 130, for example by using the interpolation method. Then, the first calculating unit 76 outputs the calculation result to the correcting unit 77 as the third signal. The method of calculating the inner temperature of DUT100 corresponding to the heat generating portion by the calculating unit 76 from the plurality of second signals is not particularly limited to the above-described interpolation method.

The correcting unit 77 sets the target temperature Tsp′ by correcting the reference value Tsp, which is set by the reference setting unit 82, using the third signal outputted from the first calculating unit 76. Here, the third signal based on the first signal indicating the internal temperature of the DUT 100 with high accuracy should match the reference value Tsp. Therefore, in one or more embodiments, the correcting unit 77 automatically adjusts the target temperature Tsp′ in consideration of the third signal by adding the difference between the reference value Tsp and the third signal to the reference value Tsp. Specifically, the correcting unit 77 includes a second calculating unit 771, an adjusting unit 772, and a third calculating unit 773. The method of correcting the reference value Tsp by the correcting unit 77 is not particularly limited to the method described below.

The second calculating unit 771 receives the reference value Tsp from the reference setting unit 72 and also receives the third signal from the first calculating unit 76. Then, the second calculating unit 771 calculates the difference ΔT between the reference value Tsp and the third signal and outputs the difference ΔT to the adjusting unit 772.

The adjusting unit 772 adjusts the difference ΔT calculated by the second calculating unit 771 and outputs the adjusted difference ΔT to the third calculating unit 773. Specifically, the adjusting unit 772 adjusts the difference ΔT by multiplying the difference ΔT by a gain constant K. For example, the gain constant K is set to be less than 1 (K<1), and the adjusting unit 772 adjusts the difference ΔT to be small. As a result, it is possible to suppress rapid variation of the third signal and stabilize the behavior of the controller 70. The adjusting unit 772 may adjust the difference ΔT using PID control instead of the above-mentioned proportional control. Furthermore, if the reliability of the third signal is high, the gain constant K may be set to 1 (K=1) or may be larger than 1 (K>1).

The third calculating unit 773 receives the adjusted difference ΔT from the adjusting unit 772 and also receives the reference value Tsp from the reference setting unit 72. Then, the third calculating unit 773 calculates the target temperature Tsp′ by adding the difference ΔT adjusted by the adjusting unit 772 to the reference value Tsp, and the third calculating unit 773 outputs this target temperature Tsp′ to the control unit 78.

The control unit 78 controls the temperature adjuster 60 based on the target temperature Tsp′ set by the target temperature setting unit 71. The control unit 78 includes a fourth calculating unit 781. The second acquirer 80 is connected to the fourth calculating unit 781.

The second acquirer 80 includes an A/D converter 81. The A/D converter 81 is connected to the socket 20 and is also connected to the fourth calculating unit 781. As described above, the thermal diode 120 of the DUT 100 is connected to the terminal 140 of the DUT 100. When the DUT 100 is pressed against the socket 20, the thermal diode 120 and the A/D converter 81 are electrically connected via the terminal 140 of the DUT 100 and the contactor 21 of the socket 20, and the fourth signal indicating the internal temperature of the DUT 100 is transmitted from the thermal diode 120 to the A/D converter 81.

Since the fourth signal outputted from the thermal diode 120 is an analog signal, the fourth signal is continuously outputted from the thermal diode 120 to the A/D converter 81. Further, the dedicated connector 21 is assigned to the thermal diode 120, and the above-mentioned analog signal is always outputted from the thermal diode 120 to the A/D converter 81.

The A/D converter 81 converts the fourth signal outputted from thermal diode 120 into a digital signal and outputs the digital signal to the fourth calculating unit 781 as the fifth signal Ttd. The fifith signal Ttd is a signal obtained by simply performing digital conversion on the analog signal outputted from the thermal diode 120, and the A/D converter 81 does not perform calculating such as correcting the analog signal.

The fourth calculating unit 781 calculates the difference between the target temperature Tsp′ inputted from the third calculating unit 773 of the target temperature setting unit 71 and the fifth signal Ttd inputted form the second acquirer 80. Then, the control unit 78 calculates a control amount to reduce this difference by of PID control and adjusts the temperature of the fluid passing through the inner space 54 of the pusher 53 by performing PWM control on the temperature adjuster 60 according to the control amount. Specifically, the control unit 78 adjusts the flow rate of the fluid flowing from the second flow passage 632 to the third flow passage 633 by PWM controlling the flow regulator 645 in accordance with the above control amount. Therefore, the mixing ratio of the first fluid and the second fluid is adjusted, that is, the temperature of the mixed fluid is adjusted.

Instead of the output from the thermal diode 120, the detection result detected by the temperature sensor 56 disposed in the pusher 53 of the contact arm 51 may be inputted to the fourth calculating unit 781. Alternatively, instead of the output from the thermal diode 120, the detection result detected by the temperature sensor 65 included in the temperature adjuster 60 may be inputted to the fourth calculating unit 781. Alternatively, instead of the output from the thermal diode 120, for example, a corrected value Tj′ obtained by correcting the junction temperature Tj with an analog signal of a thermal diode as described in US 2019/0101587 A may be inputted to the fourth calculating unit 781.

As described above, in one or more embodiments, the first acquirers 40a to 40c respectively acquire the first signals and respectively output the second signals, the first signals are respectively outputted from the DTS 130a to 130c and respectively indicate the internal temperatures of the DUT, and the controller 70 controls the temperature adjuster 60 using the second signals. Therefore, even when the temperature distribution of the DUT 100 is uneven due to the circuit of the DUT100 being partially driven, it is possible to detect the temperature of the driving portion of the circuit being tested in DUT 100, and it is possible to improve the accuracy of temperature adjustment.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, although the correcting unit 77 corrects the target temperature Tsp in the above embodiments, the correction object of the correcting unit 77 is not limited to this, and the correcting unit 77 may correct the fifth signal Ttd outputted from the second acquirer 80 that acquires the fourth signal from the thermal diode 120.

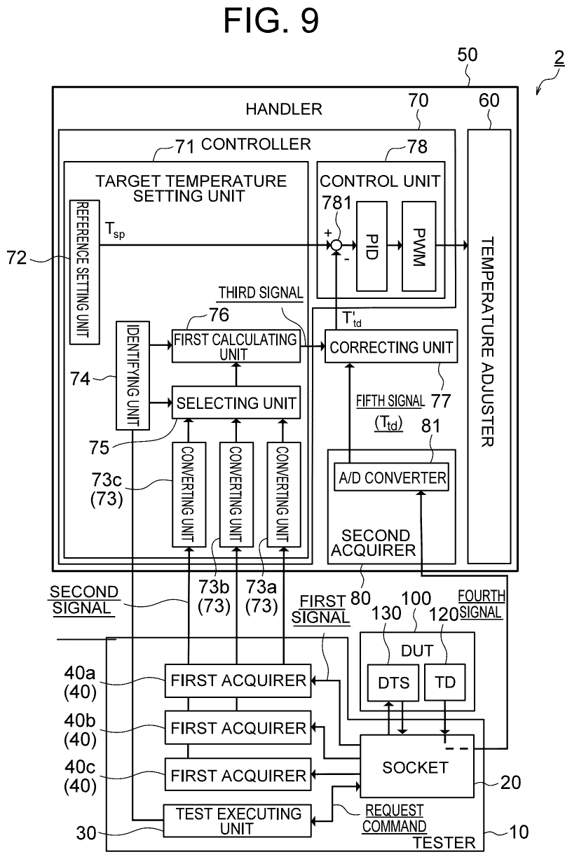

In this case, as shown in FIG. 9, the reference setting unit 72 inputs the reference value Tsp as the target temperature directly to the fourth calculating unit 781 of the control unit 78, and the correcting unit 77 is interposed between the second acquirer 80 and the fourth calculating unit 781, and the correcting unit 77 corrects the fifth signal Ttd and inputs the corrected fifth signal Ttd′ to the fourth calculating unit 781. Although not particularly shown, the correcting unit 77 includes the second calculating unit 771 that calculates the difference between the third signal and the fifth signal Ttd, the adjusting unit 772 that adjusts the difference, and the third calculating unit 773 that adds the adjusted difference to the fifth signal Ttd. The fourth calculating unit 781 calculates the difference between the reference value Tsp and the corrected fifth signal Ttd′, and the control unit 78 controls the temperature adjuster 60 based on the difference. FIG. 9 is a block diagram showing a modification of the controller in one or more embodiments.

Although the tester 10 includes the acquiring unit 41, the normalization processing unit 42, the averaging processing unit 43, and the switching unit 44 in the above-described embodiments, it is not particularly limited to this. For example, the handler 50 may include at least one of the acquiring unit 41, the normalization processing unit 42, the averaging processing unit 43, and the switching unit 44. Further, although the handler 50 includes the target temperature setting unit 71 and the control unit 78 in the above-described embodiments, it is not particularly limited to this. For example, the tester 10 may include at least one of the target temperature setting unit 71 and the control unit 78.

Although an example in which the temperature control using the second signals is applied to the back-end process electronic device testing apparatus 1 including the tester 10 and the handler 50 is described in the above-described embodiments, the temperature control using the second signals described above may also be applied to a front-end process (wafer process) semiconductor testing apparatus including a prober. Alternatively, the temperature control using the second signals described above may be applied to a burn-in apparatus or an SLT (System Level Test) apparatus.

### Explanations Of Letters Or Numerals

1 . . . . Device testing apparatus
2 . . . . Temperature adjusting system
10 . . . . Tester
30 . . . . Test executing unit
40, 40a to 40c . . . . First acquirer
50 . . . . Handler
51 . . . . Contact arm
53 . . . . Pusher
54 . . . . Inner space
56 . . . . Temperature sensor
60 . . . . Temperature adjuster
70 . . . . Controller
71 . . . . Target temperature setting unit
72 . . . . Reference setting unit
73, 73a to 73c . . . . Converting unit
74 . . . . Identifying unit
75 . . . . Selecting unit
76 . . . . First calculating unit
77 . . . . Correcting unit
78 . . . . Control unit
80 . . . . Second acquirer
81 . . . . A/D converter
100 . . . . DUT
101 . . . . Portion
110 . . . . Main circuit
120 . . . . Thermal diode (second temperature detecting circuit)
130, 130a to 103c . . . . DTS (first temperature detecting circuit)
200 . . . . Carrier

What is claimed is:

1. A temperature adjusting system comprising:
a temperature adjuster that adjusts a temperature of a device under test (DUT) including first temperature detecting circuits;
first acquirers each of which:
acquires a first signal, output from a corresponding one of the first temperature detecting circuits, indicating an internal temperature of the DUT, and
outputs a second signal; and
a controller that controls the temperature adjuster based on the output second signals.

2. The temperature adjusting system according to claim 1, wherein the controller:
selects one or more second signals from the output second signals, and
controls the temperature adjuster based on the selected one or more second signals.

3. The temperature adjusting system according to claim 2, wherein the controller:
calculates a third signal based on the selected one or more second signals, and
controls the temperature adjuster based on the calculated third signal.

4. The temperature adjusting system according to claim 1, wherein the controller:
calculates a third signal based on the output second signals, and
controls the temperature adjuster based on the calculated third signal.

5. The temperature adjusting system according to claim 1, wherein the controller identifies a heat generating portion of the DUT based on test instructions under execution for testing the DUT.

6. The temperature adjusting system according to claim 1, wherein
each of the first acquirers irregularly outputs the second signal, and
the controller converts each of the irregularly output second signals to a regular signal.

7. The temperature adjusting system according to claim 1, wherein each of the first acquirers acquires the first signal from the corresponding one of the first temperature detecting circuits based on test instructions under execution for testing the DUT.

8. The temperature adjusting system according to claim 1, wherein each of the output first signals is a digital signal.

9. The temperature adjusting system according to claim 1, further comprising:
a second acquirer that:
acquires a signal, output from a second temperature detecting circuit in the DUT, indicating an internal temperature of the DUT, and
outputs a signal, wherein
the controller controls the temperature adjuster based on the output second signals and the signal output from the second acquirer.

10. The temperature adjusting system according to claim 9, wherein the signal output from the second temperature detecting circuit is an analog signal.

11. The temperature adjusting system according to claim 1, further comprising:
a temperature sensor disposed in a pusher that presses the DUT or a carrier containing the DUT against a socket, wherein
the controller controls the temperature adjuster based on the output second signals and a detection result from the temperature sensor.

12. A controller that controls a temperature adjuster that adjusts a temperature of a device under test (DUT) including temperature detecting circuits, wherein
the controller controls the temperature adjuster based on signals output from acquirers each of which acquires a signal that is output from a corresponding one of the temperature detecting circuits and indicates an internal temperature of the DUT.

13. A device handling apparatus that handles the DUT or a carrier containing the DUT and presses the DUT or the carrier against a socket, the device handling apparatus comprising:
the temperature adjuster; and
the controller according to claim 12.

14. The device handling apparatus according to claim 13, further comprising:
a pusher that presses the DUT or the carrier against the socket; and
a temperature sensor disposed in the pusher, wherein
the controller controls the temperature adjuster based on the signals output from the acquirers and a detection result from the temperature sensor.

15. A tester that tests a device under test (DUT) electrically connected to a socket or the DUT contained in a carrier electrically connected to the socket, the DUT including temperature detecting circuits, the tester comprising:
acquirers each of which:
acquires a first signal, output from a corresponding one of the temperature detecting circuits, indicating an internal temperature of the DUT, and
outputs a second digital signal.

16. A device testing apparatus that tests the DUT electrically connected to a socket or the DUT contained in a carrier electrically connected to the socket, the device testing apparatus comprising:
the temperature adjusting system according to claim 1.

17. A device testing apparatus that tests the DUT electrically connected to a socket or the DUT contained in a carrier electrically connected to the socket, the device testing apparatus comprising:
the temperature adjuster;
the controller according to claim 12; and
a tester comprising the acquirers, wherein
the signal output from each of the acquirers is a digital signal.

18. A device testing apparatus that tests the DUT electrically connected to the socket or the DUT contained in the carrier electrically connected to the socket, the device testing apparatus comprising:
the device handling apparatus according to claim 13; and
a tester comprising the acquirers, wherein
the signal output from each of the acquirers is a digital signal.
